(19) United States
(12) Patent Application Publication
(10) Pub. No.: US 2006/0240877 A1
(43) Pub. Date: Oct. 26, 2006

(54) System and method for providing in-coming call alerts

(76) Inventors: Viktor Filiba, San Diego, CA (US); Diego Kaplan, San Diego, CA (US)

Correspondence Address: KYOCERA WIRELESS CORP., P.O. BOX 928289, SAN DIEGO, CA, 92192-8289, US

(21) Appl. No.: 11/112,495

(22) Filed: Apr. 22, 2005

(51) Int. Cl. H04B 1/38; H04M 1/00

(52) U.S. Cl. 455/567

(57) ABSTRACT

An automated process and system for setting an alert style for a communications device is provided. A scheduling program is used to define one or more activities. The scheduling program may operate on the communication device, or may be operated remotely. An alert style is selected and associated with a particular activity. When an incoming call is received during the activity, the communications device uses the selected alert style. An override condition or rule may also further adjust the alert style used by communications device.

### CROSS REFERENCE TO RELATED APPLICATIONS

Not applicable.

### STATEMENT REGARDING FEDERALLY SPONSORED RESEARCH AND DEVELOPMENT

Not applicable.

### REFERENCE TO A COMPUTER LISTING, A TABLE, OR A COMPUTER PROGRAM LISTING COMPACT DISK APPENDIX

Not applicable.

### BACKGROUND

1. Field

The present invention relates generally to providing an incoming call alert, and more specifically to providing incoming call alerts for a wireless communication device.

2. Description of Related Art

Wireless communication devices are widely used, and have become an essential aspect of modern life. Wireless communication devices such as pagers, mobile phones, text pagers, PDA's (personal data assistants) are used for work, for personal activities, and as a way to keep in contact with family and friends. In this regard, it is not uncommon for an individual to have more than one wireless device, or even to carry multiple wireless devices at one time. For example, a person may have a personal mobile phone, a work mobile phone, a pager, and an instant messaging text device. Depending on the time of day and the activity the person is undertaking will determine which mobile device or devices the person carries. Each of the wireless devices typically is configurable to provide alternative incoming call alerts. Most devices will have speakers for presenting an audible ring tone, with the volume and specific tone configurable as options. Other devices have vibrators, which physically shake the device when there is an incoming call or message. When worn on the body, these devices alert the wearer to an incoming call without generating a disruptive audible ring tone alert. Other devices may flash or illuminate lamps responsive to an incoming call. By setting the configuration properly, the user may set the wireless device to have no alert generated responsive to an incoming call or message, to silently vibrate or flash, or to generate an audible ring tone at an acceptable volume and tone. Most often, the user configures the wireless device by setting menu configurations, or by pressing one or more keys on the device. This inconvenient manual configuration process may entail several steps, and is likely to be different for each wireless device.

Although mobile wireless devices are ubiquitous, the mores and etiquette associated with their use is still developing. For example, it is almost universally accepted that it is impolite to allow a mobile phone to ring during an opera or theatrical performance, and generally unacceptable to even answer the phone in those places. Work, too, has its formal and informal “rules” regarding use of mobile wireless devices. For example, a mid-level manager may discourage devices from audibly ringing during his or her meeting, but would still approve of employees receiving emergency calls from customers. As people move from activity to activity, they often need to reconfigure the devices to provide incoming call alerts in a different style. For example, when a person attends a meeting, they may need to set all their devices to have only a silent alert, such as a vibration alert. If they forget, or configure the devices incorrectly, the device may alert with a distracting and embarrassing loud ring. Further, when the meeting is over, the user needs to reconfigure the devices to have a more aggressive incoming call alert. Failing to do so may result in missed calls. Accordingly there exists a need to allow the user of a mobile communication device to more easily change alert styles according to the user's activities.

### SUMMARY

Briefly, the present invention provides an automated process and system for setting an alert style for a communications device. A scheduling program is used to define one or more activities. The scheduling program may operate on the communication device, or may be operated remotely. An alert style is selected and associated with a particular activity. When an incoming call is received during the activity, the communications device uses the selected alert style. An override condition or rule may also further adjust the alert style used by communications device.

In a more specific example, a wireless mobile device has a set of alert devices. The alert devices may include an audio speaker, a vibrator, or a set of lamps. A scheduler program is used to define activities in a daily schedule, and a scheduling process operates on a mobile wireless device. The mobile communication device cooperates with the scheduler program to enable the user to easily and flexibly control incoming call alerts. In this regard, a specific alert-style is selected and associated with one or more of the defined activities. The alert style may include providing no alert at all, or may include audible, vibration, or flashing alerts. When an incoming call is received at the mobile wireless device, and the call is received during a defined activity, the mobile device uses the alert style associated with the activity. In this way, the mobile phone is automatically configured to use a particular alert-style during predefined activities. As the user progress through the day, the mobile device adjusts its alert-style according to the activities defined in the user's schedule.

These and other features of the present invention will become apparent from a reading of the following description, and may be realized by means of the instrumentalities and combinations particularly pointed out in the appended claims.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a block diagram a wireless communication device in accordance with the present invention.

FIG. 2 is a flowchart of a method for providing an alert in accordance with the present invention.

FIG. 3 is a flowchart of a method for providing an alert in accordance with the present invention.

FIG. 4 is a flowchart of a method for providing an alert in accordance with the present invention.

FIG. 5 is a simplified display for a scheduling system in accordance with the present invention.

FIG. 6 is a simplified display for a scheduling system in accordance with the present invention.

FIG. 7 is a simplified display for a scheduling system in accordance with the present invention.

FIG. 8 is a simplified display for a scheduling system in accordance with the present invention.

### DETAILED DESCRIPTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

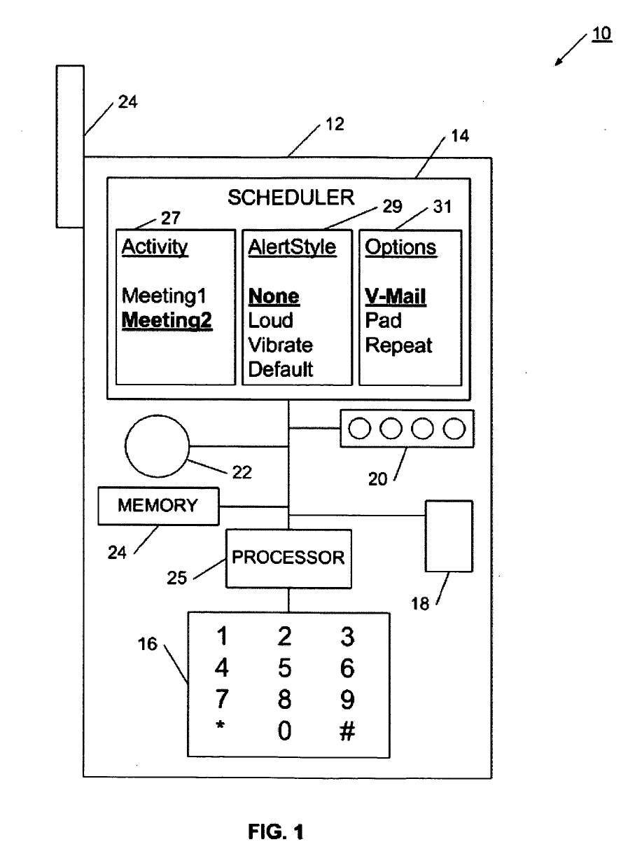

Referring now to FIG. 1, a communication device 10 is illustrated. Communication device 10 is in the form of a mobile phone 12, which is constructed to transmit and receive wireless communications. Although communication device 10 is illustrated as mobile phone 12, it will be appreciated that other communication devices may be used. For example, the communication device may be a pager, walkie-talkie, personal data assistant, or other portable computing device. Mobile phone 12 includes a display 14 for presenting visual information to a user. Such information may include text, as well as graphics, images, and videos. The display 14 also cooperates with other input devices on the mobile phone 12 to assist the user in making configuration settings for the mobile phone 12. Mobile phone 12 also includes a keypad 16 to enable a user to control and command the phone by pressing keys. The keypad 16 may include number keys, special function keys, software define keys, as well as other controls such as sliders, toggles, and joystick inputs.

The mobile phone 12 also includes a processor 25 for providing both call processing and application processing support. Although a single processor 25 is illustrated, it will be appreciated that processor 25 may actually be arranged as a set of cooperating processors or circuits. The processor 25 has an associated memory 24, where data, applications, and configuration settings may be stored. It will be understood that the memory 24 may include RAM, ROM, flash, memory cards, or other types of volatile or nonvolatile memory structures. The mobile phone 12 also includes an antenna 24 for receiving and sending radio frequency transmissions. When an incoming call is received, the radio frequency communication is received at the antenna 24, and a radio (not shown) receives and demodulates the radio frequency communication. The radio notifies the processor 25 that an incoming call is being received. The incoming call may be, for example, an incoming voice communication, a text message, a video message, or page. It will be understood that FIG. 1 is a simplified block diagram of a mobile communication device, and for ease of discussion, does not illustrate all the components and modules of a mobile phone. However, the design and construction of mobile communication devices is well known, so will not be discussed in detail.

The mobile phone 12 operates a scheduler program, which enables a user to define activities in a schedule or time format. For example, a typical scheduler process enables a user to input a daily, weekly, or monthly schedule in a calendar-like format. In this way, a user may enter start and stop time for meetings, appointments, and other events or activities. Scheduler programs are widely used on desktop computers, portable data assistants, and mobile phones. The general design and implementation of a scheduler program is well known, so will not be discussed in detail.

The mobile communication device cooperates with the scheduler program to enable the user to easily and flexibly control incoming call alerts. In the process of using the scheduler program to define an activity 27, a user selects and associates an alert-style 28 to a particular activity. When an incoming call is received at most mobile communication devices, the device will alert the user that a call or message is being received. Often, the mobile device will sound a ring tone, vibrate, or flash a set of lamps. Other times, the user may set the device not to provide any alert at all. This is convenient, for example, if the user does not want to be disturbed by an incoming call. The types of available alert-styles may vary depending upon what alert devices are provided for the mobile phone 12. For example, if mobile phone 12 has a vibration device 18, then the alert-styles 28 may include a vibrate mode, as well as a vibrate-first-and-then-ring. In this way, if the user does not answer in a set number of vibrations, then the phone will sound an audible ring tone alert. Also, the mobile phone 12 may include a speaker 22 for projecting an audible ring tone. Other audible alert-styles may set a soft, loud, or escalating ring tone volume. Some mobile phones permit a user to download and play custom ring tones, so an additional alert-style may select a particular ring tone. In another example, the mobile phone 12 may have a lamp or set of lamps 20 which may be activated upon an incoming call. If so, then the alert-style may include lights-on, lights-off, or lights-flash.

Mobile phone 12 is shown with an activity “meeting 2” selected in the schedule display area 27. Although not shown, “meeting 2” has a start time and a stop time, and may include other information regarding the meeting. The user has a set of available alert styles presented in the alert style area 29. Here, the user has selected the “none” alert-style, and has associated the “none” alert style with “meeting 2”. In this way, if an incoming call is received during “meeting 2”, the mobile phone 12 will not sound a ring tone, will not vibrate the vibrator 18, and will not flash any of the lights 20. For additional flexibility, the mobile phone 12 may allow options 31 to be set for the alert-style that has been selected for an associated activity. For example, the user has selected the “V-mail” option. This option would immediately direct the incoming caller into a voice mail system, so the caller does not have to hear the normal rings prior to entering the voice mail system.

Advantageously, the mobile phone 12 is thereby configured to use a particular alert-style during predefined activities. In this way, the user does not have to remember to turn the ringer on or off, adjust volume, or otherwise manipulate alert settings as the user goes about his or her daily activities. In a further example, the scheduler in the mobile phone 12 is configured to synchronize with the user's desktop or network based schedule. Such a synchronization configuration may be done wirelessly, or through a wired connection. In this way, the user's electronic calendar could be imported and used to set the activities in the mobile phone scheduler.

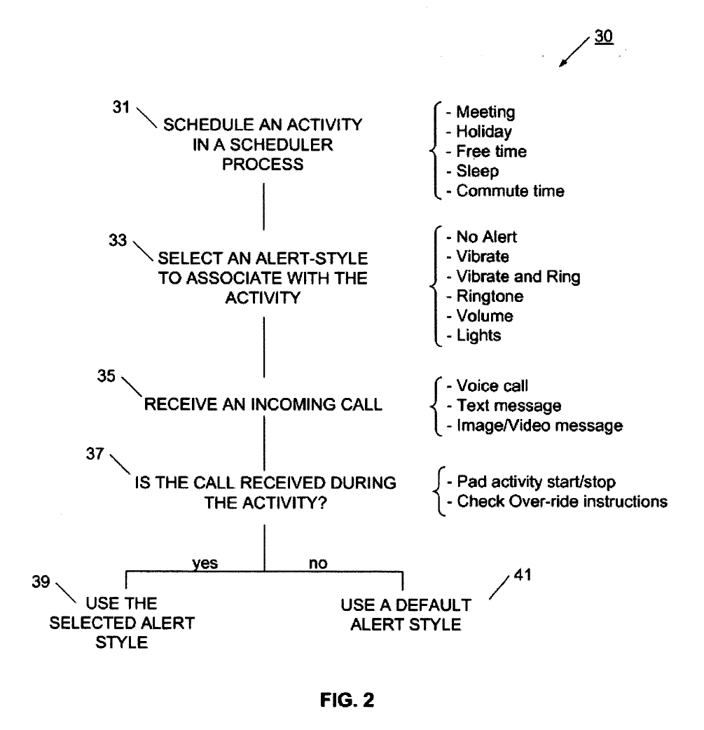

Referring now to FIG. 2, a method of providing an alert 30 is illustrated. Method 30 may operate on a wireless communication device, and enables a user to select and associate a particular alert-style with a scheduled activity. In method 30, a scheduler process operates to schedule an activity as shown in block 31. The scheduler process may be operated on the mobile communication device, or may be operated remotely, such as on a desktop computer system. The activity may be, for example a meeting, holiday time, free time, sleep time, or commute time. It will be understood that other types of activities may be programmed into a scheduler. It will also be understood that the scheduler may have default settings defined for the user. For example, a user-specific default setting may be used by the scheduler to define that the times from 8 am to 5 pm, Monday through Friday, are work hours, and all other hours are personal time for a particular user. The method then may have default alert-styles which apply to these broad categories. Then, as additional activities are scheduled, these additional activities modify the default alert-style according to the selections and associations active in the method 30. It will also be understood that the activities may be received from the user manually, or may be imported from other computer or network resources. For example, a user may import calendar or schedule activities from a desktop computer system or network resource. Upon importing the activities into the mobile wireless device, the scheduler on the mobile phone may apply particular defaults to different types of imported activities. For example, every imported meeting may have a default alert-style attached, or in a more sophisticated arrangement, a particular alert-style may be set for any meeting having a particular individual.

As shown in block 33, the method 30 associates an alert-style with an activity. This association may be done according to inputs received from a user, or may be automatically assigned depending upon the properties of the activity. The types of available alert-styles may depend on the physical make-up of the mobile phone. Also, the alert-style may include “no alert”, where the phone provides no alert upon an incoming call. In another example, the alert-style can adjust when and how long the phone would vibrate, what type of ring tone to use, how to set the volume of the ring tone, and whether or not to flash lamps on the phone, upon receiving an incoming call or other message.

The wireless mobile device may receive an incoming call as shown in block 35. This incoming call could be, for example a voice call, a text message, an image or video message, or a page. Upon receiving an incoming call, method 30 inquires as to whether the call is being received during an activity set in the scheduler, as shown in block 37. Method 30 may also allow the user to set options or override instructions. Accordingly, the process 30 may check as to whether any option or override applies to the activity or to the identity of the caller. If the incoming call is received during the activity, and the activity has an associated alert-style, then that selected alert-style is used to generate an alert to the user as shown in block 39. If the incoming call is being received outside the time of the scheduled activity, or an override or option applies, then a different alert-style may be generated as shown in block 41. In one example, the different alert-style may be a default alert-style.

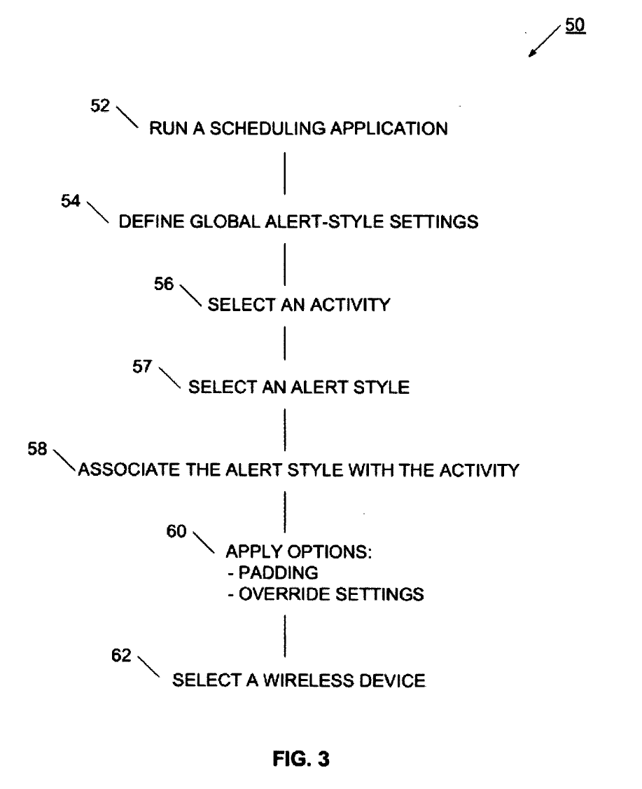

Referring now to FIG. 3, another method of providing an alert 50 is illustrated. Method 50 includes running a scheduling process on a communication device, as shown in block 52. Global alert settings may be defined as shown in block 54. These global alert settings may be set using the local mobile device, or may be retrieved from network or other remote resources. The scheduling process selects, sets, or otherwise defines a particular activity as shown in block 56. In another example, activities are selected based on their type or other properties. In this way, all meetings may be set to a particular alert-style, whereas all lunch appointments have a different alert-style. As shown in blocks 57 and 58, an alert-style may be selected and associated with a particular activity, or to a set of activities. In more advanced processes, the method may set other options or override conditions as shown in block 60. For example, a method may provide padding times for a particular activity. A padding time is an additional amount of time before or after an activity to accommodate travel time or activity overruns, for example. In this way, the selected alert-style may be set to engage a short time before an activity starts, or may extend a short time after an activity ends.

The method may also enable override conditions. For example, the user may desire that the mobile phone have no alert during a particular meeting. However, the user may always want the phone to at least vibrate if his or her manager calls. By setting override conditions, the method provides a desirable flexibility to activities and alerts. The method 50 may operate on a mobile wireless device, or parts of the process may be operated on a remote device, such as a desktop computer or network resource. Remote operation would allow, for example, an assistant to set a meeting in a manager's schedule, and associate an alert-style for that meeting. Then, the next time the manager synchronizes his or her mobile phone with the network calendar system, the meeting and its associated alert style will be defined into the manager's mobile phone.

Finally, the specific wireless device is selected as shown in block 62. Often, the wireless device selected will be the wireless device used to define the activity, and therefore is the default device. In another example, the activity may be defined and the alert selected on another computing or communication device. The device could be, for example, a desktop system, a different mobile phone, or an assistant's computer system. When using a remote device to select and associate alert styles, the remote device may use block 62 to define which particular mobile device is to be updated according to the selected alert style. For example, a user may have a business mobile phone, a personal mobile phone, and a pager. Using block 62, the method enables the user to select which of the available devices to configure. In this way, the user could have the selected alert style apply to none, selected, or all his or her mobile devices.

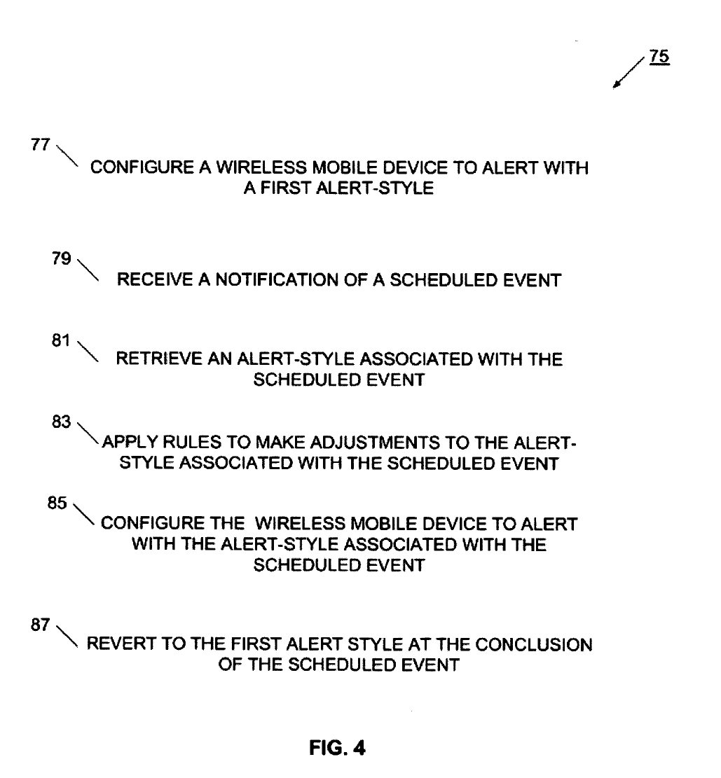

Referring now to FIG. 4, a method of providing an alert 75 is illustrated. In method 75, a mobile wireless device, such as a mobile phone, is configured to alert with a first alert-style as shown in block 77. For example, the first alert-style could be a loud standard telephone ring. The wireless mobile device operates a schedule process that, upon the start of a scheduled event, generates a notification that the event is about to begin. Process 75 receives notification of the scheduled event as shown in block 79. An alert-style has been predefined and associated with scheduled event, and method 75 retrieves that alert-style as shown in block 81. Optionally, process 75 may apply additional rules that make adjustments to the alert-style associated with the scheduled event as shown in block 83. For example, a mobile wireless device may receive caller identification information along with the incoming phone call. If the calling party is associated with contact or other profile data on the mobile device, a rule may check the profile for the identified user. In this way, the alert-style could be adjusted according to specific callers. The process 75 then configures the wireless mobile device to use the alert that has been associated with the alert-style as shown in block 85. Of course, the alert-style would be appropriately adjusted according to any of the rules or overrides. When the wireless mobile device receives an incoming call during the activity, the wireless device uses the configured alert-style to alert the user. At the conclusion of the scheduled event or activity, the wireless mobile device then reverts to the first alert-style as its default style as shown in block 87.

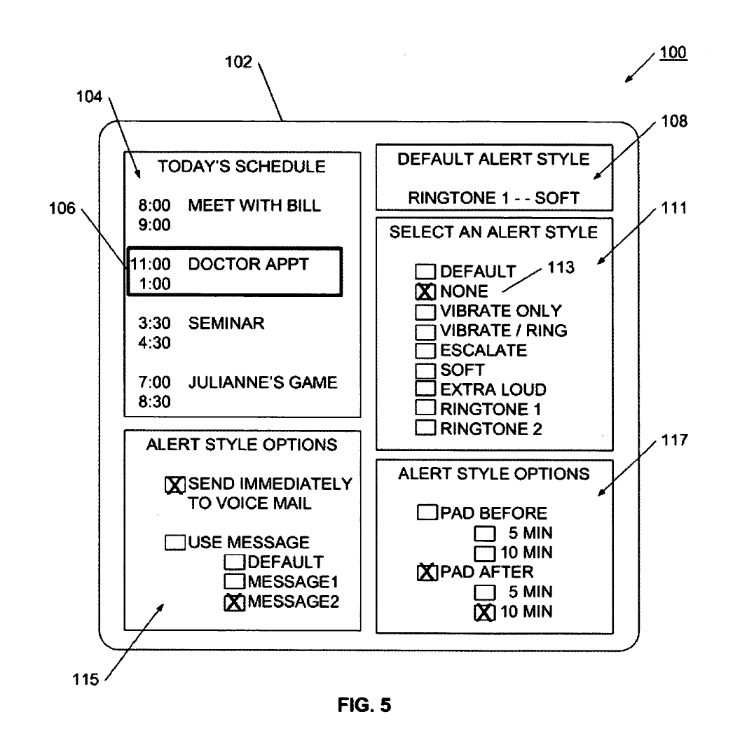

Referring now to FIG. 5, a method for selecting and assigning an alert-style is illustrated. Method 100 may be operated on a wireless communication device, such as a wireless mobile phone, or may be operated on other computer or network equipment. Method 100 will be described as operating on a wireless mobile communication device, but it will be appreciated that other devices may be used. Method 100 has a display 102 for presenting information and selection criteria to a user. Display 102 includes a schedule section 104 which presents a daily, weekly, or monthly schedule to the user. As illustrated in FIG. 5, the schedule section 104 includes 8 am to 8:30 pm of “today's” schedule. It will be understood that other time frames and presentation styles may be used. The schedule portion 104 not only shows scheduled activities, but also permits a user to edit existing activities, and add new activities to the schedule portion. Once a schedule activity has been defined, such as selected activity 106, a particular alert-style may be selected and associated with the selected activity 106. As shown in display area 108, a default alert-style may exist for the selected activity 106. If the user desires to change the default alert-style, the user may interact with selection area 111 to change the default alert-style. For example, the alert-style “none” 113 has been selected. In this way, a “none” alert-style has been associated with the “doctor appt” activity.

Also, additional options may be set. In the alert-style options area 115, the user has indicated that any caller is to be sent immediately to voice mail and message 2 is to be played. In this way, any caller will not have to wait the usual number of rings before being transferred to voice mail. Also, in alert-style options area 117, the scheduled activity has an additional 10 minutes added to its selected stop time. In this way, the selected alert-style “none” will apply to the duration of the scheduled event 106 plus an additional 10 minutes. More particularly, the “none” alert-style will apply from 11 am to 1:10 pm. Allowing a “pad” time at the start or end of scheduled activities allows a user to confidently set alert-styles even when an activity starts a bit early or extends a bit beyond its scheduled time. As shown in FIG. 5, the “soft ring tone 1” alert-style will be the default alert-style. Unless some other rule changes the alert-style, a call coming in just prior to 11 am will cause the speaker of the mobile device to project ring tone 1 in a soft volume. If a call comes in any time between 11 am and 1:10 pm, the phone will provide no audio, vibrate, or light alert, and will send the caller immediately to voice mail, where the caller will hear message 2. If the call comes just after 1:10 pm, and provided no other rules apply, then the mobile phone will again alert with a soft ring tone 1.

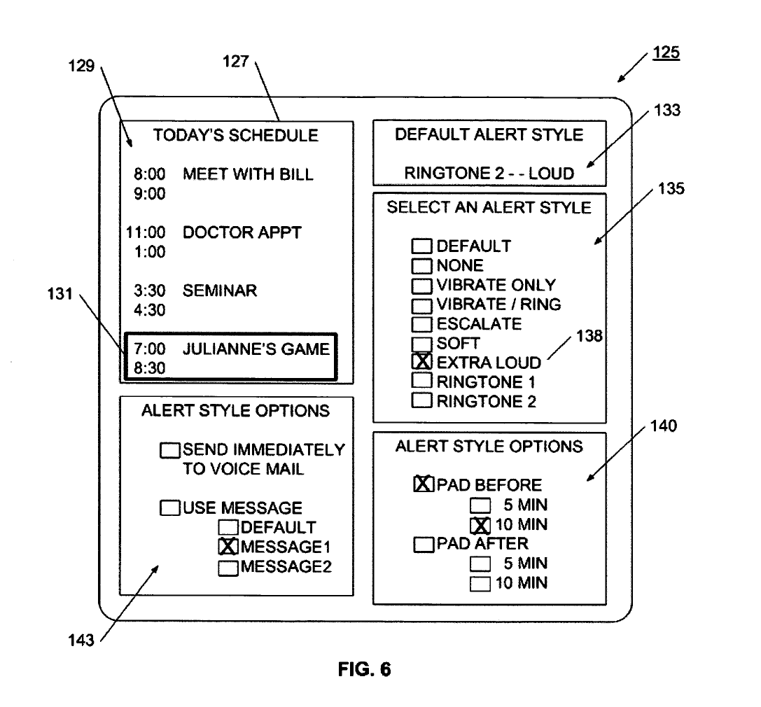

Referring now to FIG. 6, another method 125 to select and assign an alert-style is illustrated. Method 125 includes a display 127 having a scheduling portion 129. A particular activity 131 has been selected. The default alert style in effect at that time is a “loud ring tone 2” as shown in area 133. In alert-style area 135, the user has selected an extra loud 138 alert-style to apply during “Julianne's game”. Also, as shown in alert-style options area 140, the extra loud ring will be used starting 10 minutes before the 7 pm start time, but will end at 8:30 pm. As shown in option area 143, the caller will hear message 1 if the user does not answer the phone in the predetermined number of rings. As illustrated, a call arriving just before 6:50 pm will cause a “loud ring tone 2” alert. From 6:50 pm to 8:30 pm, an incoming call will generate an “extra loud” 138 alert-style. If the user does not answer the phone in a set number of rings, then the caller will hear “message 1” prior to going into a voice mail system. After 8:30 pm, an incoming call will again default to a “loud ring tone 2” alert style, unless another rule applies.

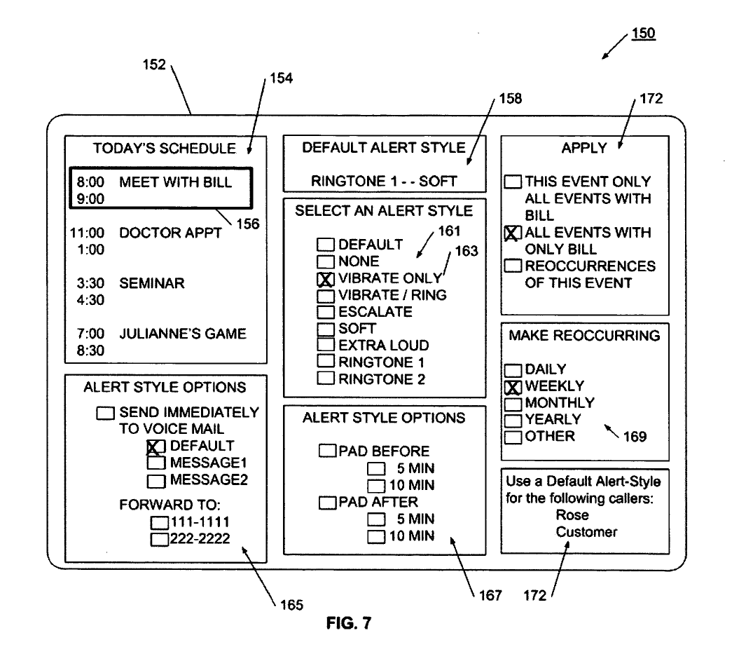

Referring now to FIG. 7, another method 150 for selecting and assigning an alert-style is illustrated. Method 150 is similar to method 100 described earlier so will not be described in detail. Method 150 has a display 152 having a schedule area 154. In schedule area 154, a particular scheduled activity 156 has been selected. A soft ring tone 1 is the default alert-style as shown in the default alert-style area 158. In the alert-style area 161, a vibrate-only 163 alert-style has been selected. The default voice mail message is to be used as shown in area 165, and area 167 shows that the style applies from the listed start to the listed stop time of the activity. Area 165 also allows the user to set a forward call number for an incoming call. In this way, the call forwarding action of the mobile device may be set according to the current activity.

Method 150 also includes other options. For example, method 150 sets a rule for the schedule process that applies this alert profile to all activities with “Bill” as the only meeting participant, as shown in area 172. In this way, irrespective of the day and time of the meeting, any meeting with only “Bill” will automatically have a vibrate-only alert-style assigned and associated. Further, as shown in block 169, this selected meeting 156 is made to occur weekly, so that the user does not have to reenter the scheduled meeting and its associated alert-style. Override area 172 permits the user of the mobile phone to set override rules for the alert-style selected in the alert-style area 161. As shown in FIG. 7, if “Rose” calls, then a soft ring tone 1 will apply. In a similar manner if any person found in the contact group “customer” calls, then the alert of soft ring tone 1 will be used. It will be understood that the override rules may be implemented in alternative ways, and may include several levels of complexity. For example, method 150 could allow the default alert-style to also be changed. A user may want to change the default alert-style to a-vibrate-and-then-ring mode, rather than having the mobile device immediately audibly ring if “Rose” or a “customer” should call.

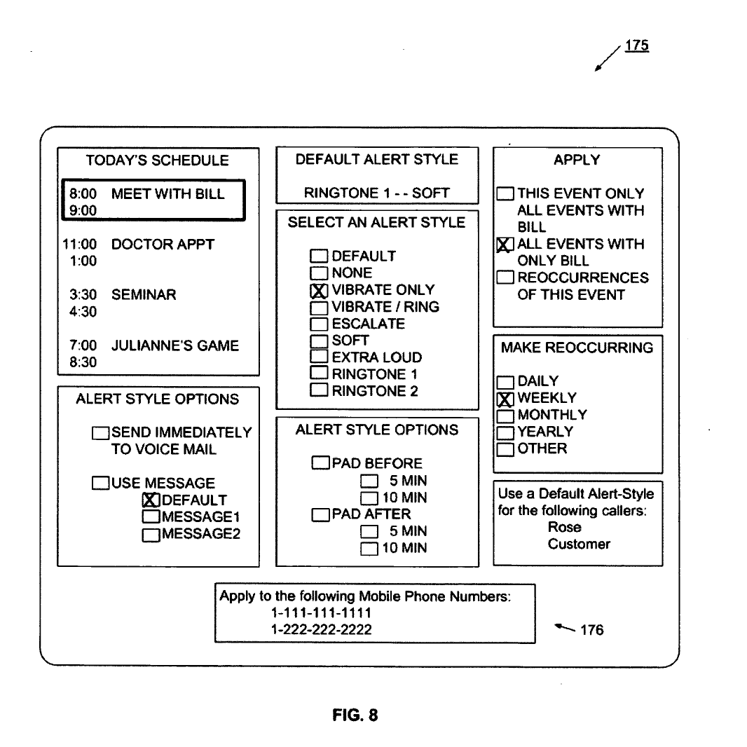

Referring now to FIG. 8, another method for selecting and assigning an alert-style is illustrated. Method 175 is similar to method 150 described earlier, so therefore will not be discussed in detail. As compared to method 150, method 175 adds a mobile identification area 176. The mobile identification area 176 enables a user to select which mobile device or devices that the selected alert-style should apply to. This is convenient, for example, when a user has multiple phones. Also, it is useful for a desktop computer user to define and adjust schedule options using a desktop computer, and then through a wireless or wired connection synchronize to one or more mobile phones. In one example, process 175 is operated on a desktop computer or on another network computing device. In another example, process 175 may be operated on a wireless mobile device.

While particular preferred and alternative embodiments of the present intention have been disclosed, it will be apparent to one of ordinary skill in the art that many various modifications and extensions of the above described technology may be implemented using the teaching of this invention described herein. All such modifications and extensions are intended to be included within the true spirit and scope of the invention as discussed in the appended claims.

What is claimed is:

1. A method of providing an alert, comprising:
receiving an activity in a scheduler process;
associating an alert style with the activity;
receiving an incoming wireless communication;
determining if the incoming wireless communication is received during the activity; and
using the selected alert style if the incoming wireless communication is received during the activity.

2. The method according to claim 1, further comprising the step of using a different alert-style if the incoming wireless communication is not received during the activity.

3. The method according to claim 1, wherein the selected alert-style is to not provide any alert.

4. The method according to claim 1, wherein the selected alert-style is vibrate only.

5. The method according to claim 1, further including padding the start or stop time of the activity, and treating the padding as occurring during the activity.

6. A method of responding to an incoming wireless communications call, comprising:
receiving an activity from a scheduler process;
retrieving an alert style associated with the activity;
receiving an indication of an incoming call; and
activating alert devices in accordance with the alert style.

7. The method according to claim 6, wherein the call is received within a predetermined padded amount of time before or after the activity.

8. The method according to claim 6, further including the step of comparing the time that the incoming call is received to a time period defined for the activity.

9. The method according to claim 6, further including the step of configuring the alert devices to use the alert style during a time period defined for the activity.

10. The method according to claim 6, further including the step of applying a different alert style responsive to checking an over-ride rule.

11. The method according to claim 6, wherein the alert style is set so that no alert device generates an audible, visible, or vibration alert.

12. The method according to claim 6, wherein the alert devices are selected from the group consisting of a vibrator, a speaker, and a lamp.

13. The method according to claim 6, further including the steps of:
retrieving a call forward number also associated with the activity; and
forwarding the incoming call to the forward number.

14. A system for providing an incoming call alert, comprising:
a processor operating the steps of:
storing an activity in a time schedule;
associating an alert style with the activity;
a mobile wireless device operating the steps of:
receiving an incoming call;
using, during the activity, the alert style.

15. The system according to claim 14, wherein the processor is in the mobile wireless device.

16. The system according to claim 14, wherein the processor is in a computing device remote from the mobile wireless device.

17. A scheduling process, comprising:
storing an activity in a time schedule;
displaying a plurality of incoming call alert styles; and
associating one of the plurality of incoming alert styles with the activity.

18. The process according to claim 17, further comprising the step of synchronizing the time schedule to a time schedule in a wireless mobile device.
